(19) United States
(12) Patent Application Publication
(10) Pub. No.: US 2026/0050062 A1
(43) Pub. Date: Feb. 19, 2026

(54) G-BAND RF SWITCH WITH HIGH POWER HANDLING CAPABILITY FOR RADAR APPLICATIONS

(71) Applicant: California Institute of Technology, Pasadena, CA (US)

(72) Inventors: Sven L. Van Berkel, Pasadena, CA (US); Ken B. Cooper, Pasadena, CA (US); Alain E. Maestrini, Pasadena, CA (US); Goutam Chattopadhyay, Pasadena, CA (US)

(73) Assignee: California Institute of Technology, Pasadena, CA (US)

(21) Appl. No.: 19/304,089

(22) Filed: Aug. 19, 2025

Related U.S. Application Data
(60) Provisional application No. 63/684,675, filed on Aug. 19, 2024.

(51) Int. Cl. G01S 7/03; H01P 3/08

(52) U.S. Cl. CPC G01S 7/032; H01P 3/081

(57) ABSTRACT

A device useful as a switch including an input waveguide coupled to an output waveguide; a first diode circuit integrated with the input waveguide at a first termination; a second diode circuit integrated with the output waveguide at a second termination; and wherein the biasing the diode circuits switches the switch between an off state and an on state and achieves high isolation in the off state by absorbing input power in, reflecting the input power from, and frequency multiplying the input power using the diodes in the diodes circuits when the input power is received from the input waveguide. In one embodiment, the switch is a tunable, solid-state SPST switch for Gband radar applications.

### CROSS REFERENCE TO RELATED APPLICATIONS

This application claims the benefit under 35 U.S.C. Section 119(e) of U.S. Provisional Application No. 63/684,675, filed Aug. 19, 2024, by Sven L. Van Berkel, Ken B. Cooper, Alain E. Maestrini, and Goutam Chattopadhyay entitled “G-BAND RF SWITCH WITH HIGH POWER HANDLING CAPABILITY FOR RADAR APPLICATIONS,” (CIT-9202-P), which application is incorporated by reference herein.

### STATEMENT REGARDING FEDERALLY SPONSORED RESEARCH AND DEVELOPMENT

This invention was made with government support under Grant No. 80NM0018D0004 awarded by NASA (JPL). The government has certain rights in the invention.

### BACKGROUND OF THE INVENTION

### Field of the Invention

The present disclosure relates to switches and methods and systems of using and making the same.

### Description of the Related Art

Radar systems operate by transmitting a signal and analyzing the reflected signal which returns information (such as distance, shape, and material properties) about the target from which the signal was reflected. High-frequency (G-band) radar systems have been developed for humidity and cloud remote sensing [1]. Significant power needs to be transmitted and extremely sensitive receivers are required in order to detect the reflected signal, because cloud particles reflect only a small portion of the transmitted power. Due to their large sensitivity, the receivers need to be protected from any leaking transmitted power, which is typically achieved by turning the receiver OFF when transmitting power, using a low-loss switch that has high power handling capability and high isolation.

Radars are also used for numerous commercial applications, with the biggest markets including the automotive industry, industrial quality control, and security screening. The frequency of the radar determines the resolution of the image that can be captured, whereas the transmit power and receiver sensitivity determine the dynamic range (i.e. quality) of the image. The backhaul of the communication network is another application, where higher frequency implies better bandwidth and switches can be used in high-power ON-OFF keying transmitters. Desirable specifications for a state of the art switch include an input power handling of +22 dBm, isolation of 32 dB, low loss <1.5 dB, and high switching speed (10 kHz).

A switch based on a piezo-electric motor meets some of the requirements but can only switch at a rate of ˜1 Hz [16]. Radar applications will need much faster switching speed, ˜10 kHz. For this reason, a solid-state switch (usually based on diodes) is more desirable. The commercially available SPST reflective switch by Eravant meets the isolation and switching requirements but does not meet power handling requirements (limited to only 5 dBm) and insertion loss requirements (limited to only 3 dB). Thus, currently there are no switches for applications that turn the receiver ON or OFF with high frequency and power. The present disclosure satisfies this need.

### SUMMARY OF THE INVENTION

An embodiment of a switch includes an input waveguide coupled to an output waveguide; a first frequency multiplier (e.g., a first diode circuit) integrated with the input waveguide at a first termination; a second frequency multiplier (e.g., second diode circuit) integrated with the output waveguide at a second termination; and wherein the operation (e.g., biasing of) the frequency multipliers, e.g., diode circuits, switches the switch between an off state and an on state and achieves high isolation in the off state by absorbing input power in, reflecting the input power from, and frequency multiplying the input power using frequency multipliers (e.g., diodes in the diode circuits) when the input power is received from the input waveguide. In one embodiment configured for operation at G-band frequencies, the switch is characterized by an input power handling of +22 dBm, isolation of 32 dB, low loss <1.5 dB, and high switching speed (10 kHz). In another embodiment, the switch comprises an ultrafast, high-performance, tunable, solid state SPST switch for G-band radar applications, achieving an ON-state insertion loss below 0.86 dB and an OFF-state isolation exceeding 43 dB at low power (0 dBm) or 30 dB at high power levels (17 dBm), wherein the instantaneous isolation bandwidth ranges from 500 MHz to 5 GHz, depending on the isolation requirements and high-speed testing demonstrated ultrafast switching at a 4 MHz rate, with an intrinsic switching time of a few nanoseconds while the switch dynamically absorbs and reflects power while also operating as a frequency doubler. In another embodiment, depending on the required isolation, the switch is tunable with an instantaneous bandwidth ranging from 300 MHz (for 30 dB isolation) to 13 GHz (for 15 dB isolation).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Referring now to the drawings in which like reference numbers represent corresponding parts throughout:

FIG. 1: State-of-the-art of high-frequency switches (G-band and above) [4].

FIG. 2A-2C: Device for switching, wherein FIG. 2A shows a schematic of the coupling of frequency multiplier chips to the hybrid coupler. FIG. 2B shows a device formed in a metal block, and FIG. 2C shows the chips used for the switching architecture

FIGS. 3A-3D. Schematic representation of the switching architecture and modes of operation, wherein FIG. 3A is a SPST switch architecture, FIG. 3B shows relevant propagating modes around the waveguide-integrated frequency doubler chips, FIG. 3C shows ON-state operation, and FIG. 3D shows OFF-state operation.

FIGS. 4A-4B illustrates the ON-state of the switch, wherein FIG. 4A shows the performance in terms of insertion loss and return loss and FIG. 4B shows the electromagnetic simulation of the ON-state.

FIGS. 5A and 5B illustrate the OFF-state of the switch, wherein FIG. 5A is the performance in terms of isolation and FIG. 5B shows the electromagnetic simulation of the OFF-state.

FIGS. 6A-6B. Switch overview with indicated key components. (1) Waveguide quadrature hybrid coupler, (2) Reduced-height waveguide and ƒf₁-backshort, (3) 2ƒ₁-backshort and power combiner, where FIG. 6A shows a Full ƒ₁ EM simulation domain and FIG. 6B shows 2ƒ₁ EM simulation domain.

FIGS. 7A-7C. Waveguide quadrature hybrid coupler with transformer section to the reduced-height waveguide, wherein FIG. 7A is a schematic with relevant dimensions, FIG. 7B shows simulated S-parameters of the network and FIG. 7C shows simulated S-parameters when shorting ports #3 and #4, representing the limiting ohmic losses in the ON state.

FIG. 8A. EM model showing the definition of the ƒ₁ and 2ƒf₁ backshort distances. This EM model is also used to simulate various 2ƒ₁ backshort distances (see FIG. 9A). The Schottky anodes are defined as waveports.

FIG. 8B. EM/Circuit co-design model to optimize the ƒ₁ backshort distance.

FIG. 8C. Simulated optimized isolation.

FIG. 8D. Simulated optimized biasing for different ƒ₁ backshort distances.

FIG. 9A. Simulation domain. for 2f1-backshort optimization. Compared to FIG. 8B, the frequency multiplied power is not directly terminated in loads but first launched in a 2f1 EM simulation to optimize the 2f1-backshort distance.

FIG. 9B. Final workbench for switch performance evaluation that includes the full 2f1 EM simulation domain with the power combining network.

FIGS. 10A-10C. The switch assembly, wherein FIG. 10A is a CAD model with one topblock removed, FIG. 10B shows a fully assembled switch, and FIG. 10C is a Zoom-in of the assembled frequency doubler chips.

FIGS. 11A-11B. Measurement setups used for the switch characterization, wherein FIG. 11A shows the setup without additional amplification and FIG. 11B shows the setup with a power amplifier and isolator

FIG. 11C shows Measured power as input to the switch for both setups in FIGS. 11A and 11B.

FIG. 12. ON-state measurement (dotted) of the switch, compared to simulations (solid). Insertion loss (blue) and return loss (orange) are shown. The measurement was performed using the setup shown in FIG. 11A, without additional amplification (Pᵢₙ≈0 dBm). The forward bias of both chips was set to 1.6V.

FIGS. 13A-13H. OFF-state measurements for Pᵢₙ≈0 dBm (−0.8 to +2.2 dBm, FIGS. 13A, 13C, 13E, and 13G) and Pᵢₙ≈15 dBm (+13 to +17 dB, FIGS. 13B, 13D, 13F, and 13H), compared to simulations. FIGS. 13A and 13 B show results for optimized measured (left subfigure) and simulated (right subfigure) biasing. Two biasing solutions exist for the measured device. FIGS. 13C and 13D show results for optimized isolation. FIGS. 13E and 13F show instantaneous isolation for a fixed biasing, showing various biasing conditions optimized for five discrete frequency points. FIGS. 13G and 13H show instantaneous bandwidth required to meet example applications.

FIGS. 14A-14B. OFF-state power budget for Pᵢₙ≈0 dBm (−0.8 to +2.2 dBm) in FIG. 14A and Pᵢₙ≈15 dBm (+13 to +17 dB) in FIG. 14B, compared to simulations. The absorbed power is not directly evaluated but derived from other parameters, assuming power conservation. The multiplied power is measured only for one biasing solution, and the reflected power is not measured in the high-power configuration.

FIGS. 15A-15B. Measurement setup for switch characterization at a 4 MHz switching speed, wherein FIG. 15A shows the instrumentation and FIG. 15B is a block diagram of the measurement setup.

FIGS. 16A-16B. Measurement results for switch characterization at a 4 MHz switching speed. FIG. 16A is time-domain data recorded by the oscilloscope of the bias signals (blue, left axis) and the IF signal V_{IF}(t) (red, right axis). Left: 1-μs data. Right: A zoom-in showing an OFF-to-ON transition. FIG. 16B shows measured isolation derived from the mean-square voltage Equation 2, averaged over M=50 measurements.

FIG. 17. Table IV.

FIG. 18. Flowchart illustrating a method of making a device or switch.

FIG. 19. Example RADAR system including the switch.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

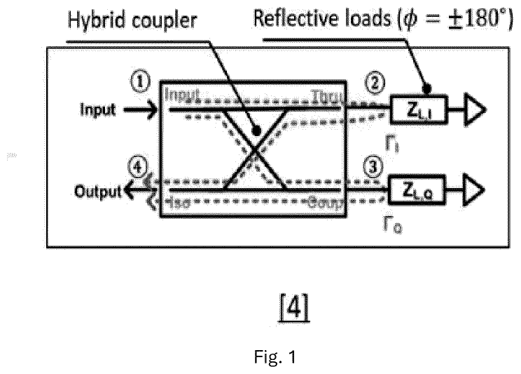

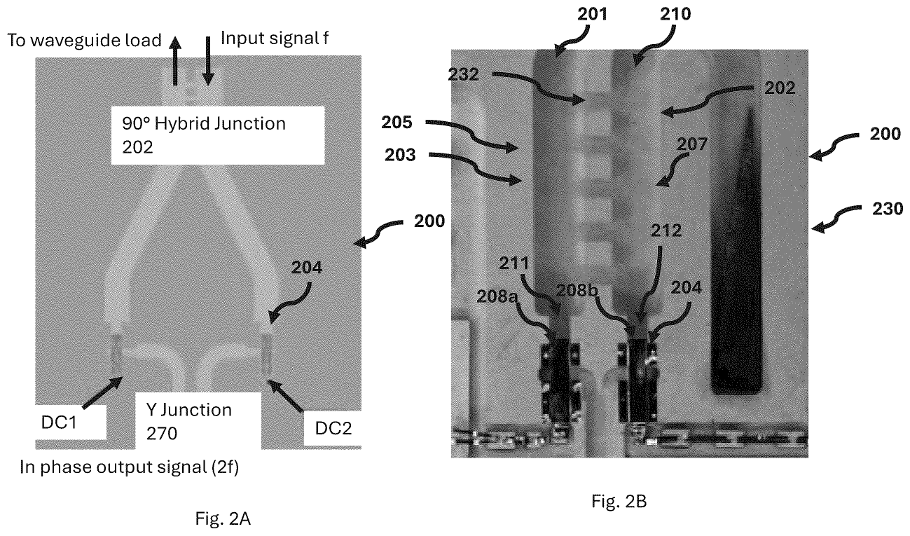

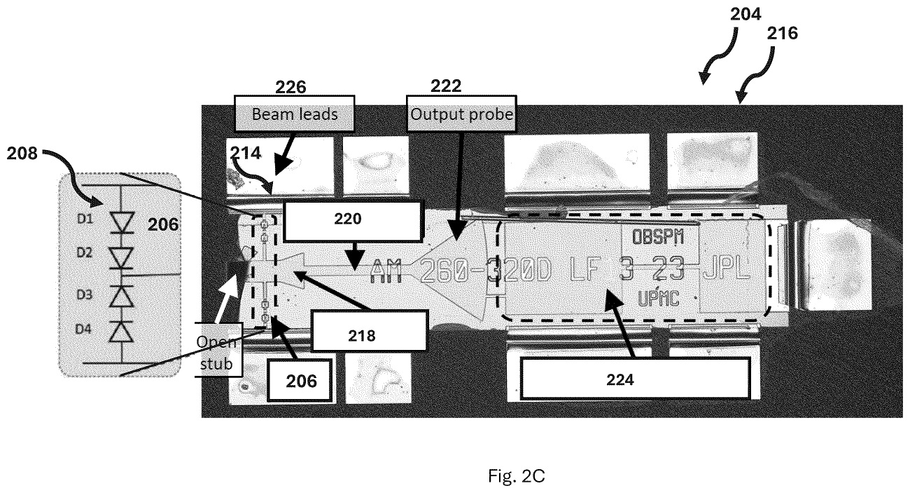

The present disclosure describes a new system for a low-loss, high-power-handling, high-isolation switch. In one embodiment, the switch utilizes a quadrature hybrid coupler approach (FIG. 1) as in [11] with two important modifications: (1) incorporation of waveguide technology (no integrated transmission lines or waveguide to chip interconnects) for low loss at high frequencies and (2) using more than purely reflective loads, so as to meet power handling and isolations specifications. More specifically, the switch achieves high isolation by absorbing, reflecting, and frequency multiplying the input power at frequency f to a higher harmonic (e.g., 2^{nd} harmonic at 2f) using frequency multipliers. FIGS. 2A and 2B illustrate an example device architecture 200 divides the signal from an input waveguide 201 using a hybrid coupler 202 and feeds the signal to two chips 204 each containing 4 Schottky diodes D1-D4 in a diode circuit 206 acting as the frequency multipliers 208 (chip and diodes illustrated in FIG. 2B). The diodes are oriented in such a way that, when properly biased with a DC-voltage, they generate higher harmonics which are then combined in a Y-junction and transmitted in an output waveguide 210. FIG. 2B illustrates the chip includes microstrip circuit 214 on a semiconductor membrane 216, wherein microstrip circuit includes diodes D1-D4, matching stub 218, microstrip transmission line 220, output probe 222, open stub, and low pass filter 224 for biasing and the chip further comprises beam leads 226.

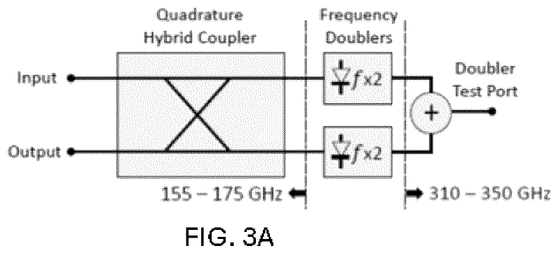

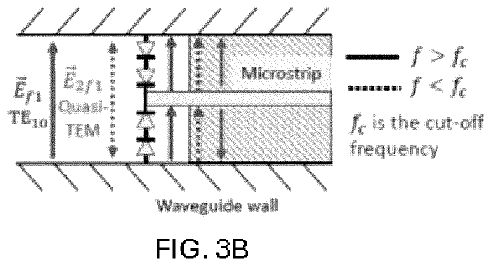

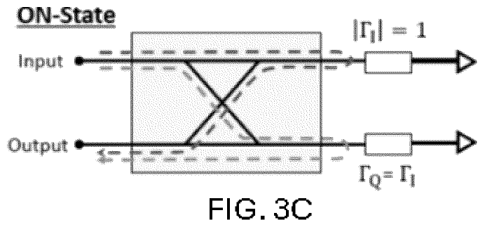

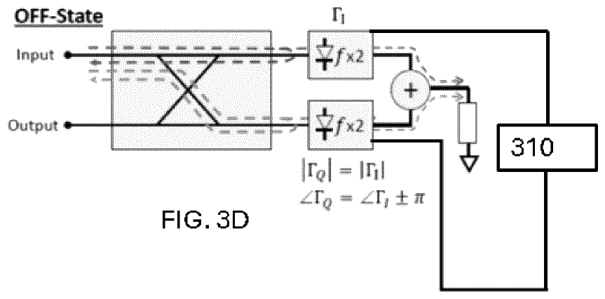

FIG. 3 illustrates a control circuit 310 can be provided to forward bias the diodes to switch the device to an on state and reverse bias the diodes to switch the device to an off state. In the on state, reflection coefficients for the signal at f1 inputted to the input port and received at the terminations are maximized (e.g., 1 or close to 1) and in phase to minimize insertion loss and maximize transmission of the signal to the output port. When forward biasing the diodes, a maximum impedance mismatch is achieved as the diodes will have a low impedance. In the off state, the diodes are reverse biased to operate the doubler in varactor mode and create an impedance match with the input and output network. In this case, the reflection coefficients at the terminations are equal in amplitude and out of phase by 180 degrees so that the signal is (1) reflected back to the input port, (2) absorbed in the diodes, or (3) multiplied to a higher frequency harmonic by the diodes.

As illustrated in FIG. 3A, the power generated at the 2^{nd} harmonic f2 can be summed and fed to a third port for characterization or terminated in a waveguide load or coupled into a long, lossy transmission line.

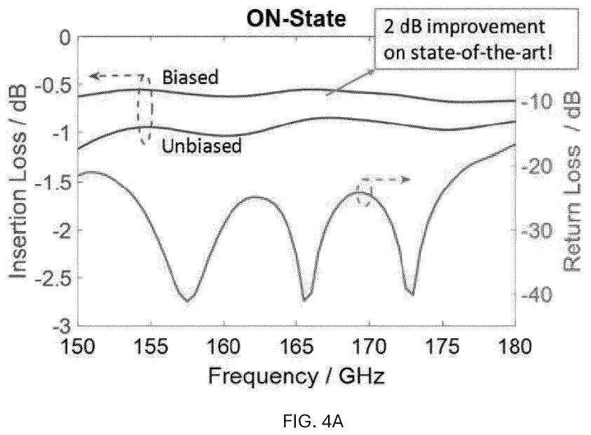

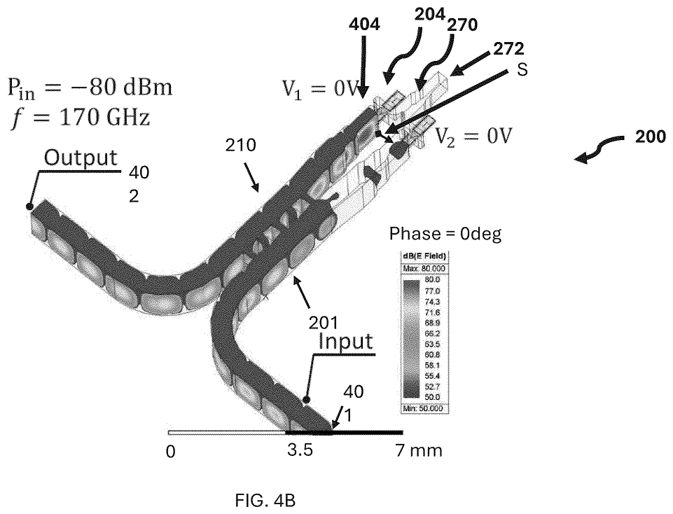

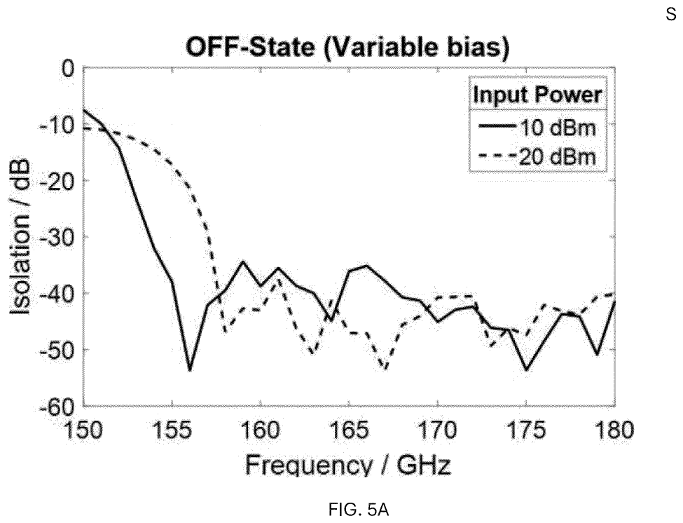

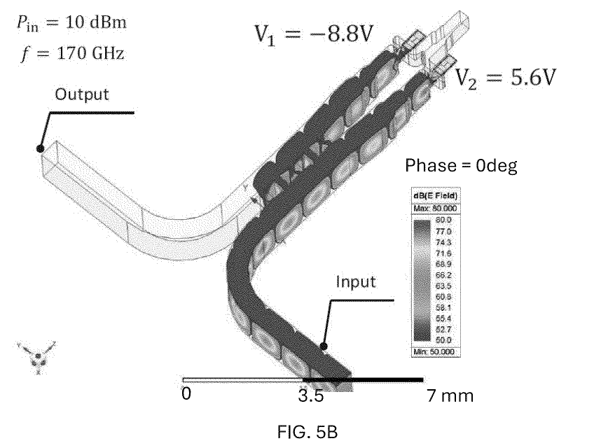

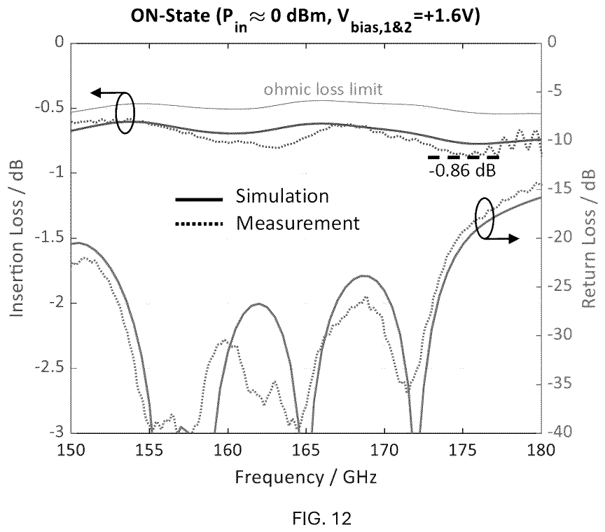

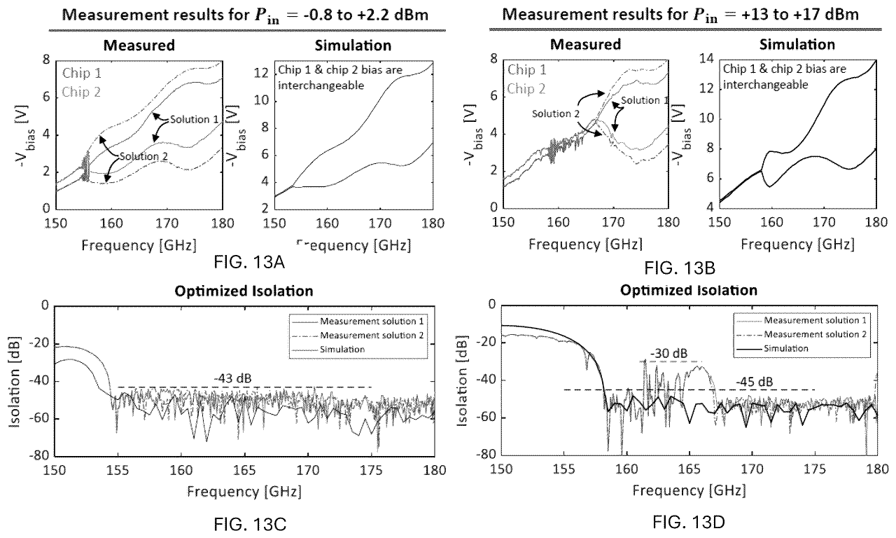

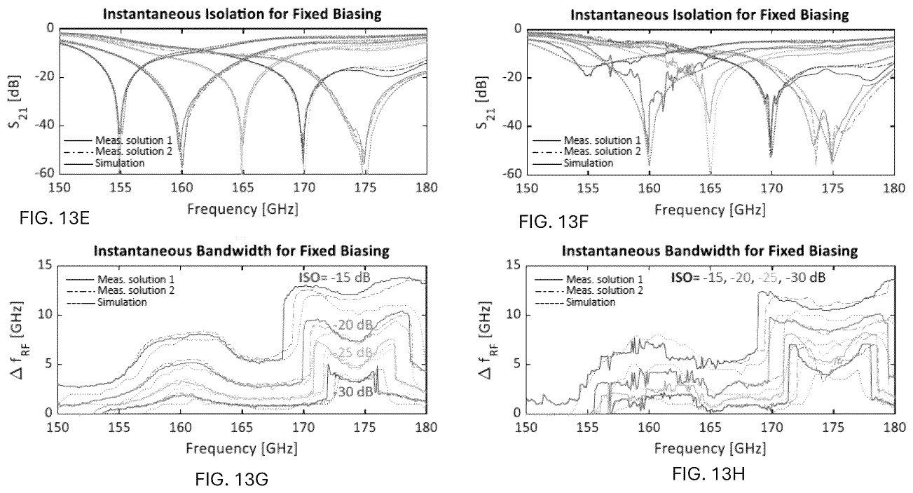

Full wave simulations of the device, illustrated in FIG. 4 and FIG. 5, and extensive Radio Frequency (RF) measurements, illustrated in FIG. 12 and FIG. 13, demonstrate the frequency architecture is not only suitable for frequency multiplication but also for switching with the following important distinctions:

Waveguide integration providing for low loss (only ˜0.5 dB of ohmic losses occur in the waveguide path).

Purely reflective switch in the ON-state. By carefully biasing the chips, a near-perfect impedance mismatch between the waveguide and chips can be realized such that all power is reflected. FIG. 4A shows excellent insertion loss, with the return loss (<−25 dB) a 2 dB improvement compared to state-of-the art devices and low loss (<−1.1 dB without biasing and <0.65 dB with variable biasing).

Power divided over multiple (in this case 2×4 diodes), providing for high power handling capability, and wherein use of more diodes and different chip designs would be capable of even higher input power.

Hybrid switch in the OFF-state. In contrast to [11], the switch does not rely on realizing a perfect 180 degree phase change to reflect all power back to the input port. Instead, the hybrid approach not only partly reflects the power but also absorbs power and generates power in a higher harmonic which is then absorbed in a third port. FIG. 5 illustrates the isolation (<−30 dB) of the switch.

This type of switching architecture is very versatile and can also be employed in different frequency bands.

### Example Device Design, Fabrication and Characterization [20]

### Design

A switch was designed for the following requirements.

TABLE I
REQUIREMENTS FOR THE G-BAND
RECEIVER PROTECTION SWITCH

| Parameter | Requirement | |
|---|---|---|
| Switching architecture | SPST | |
| Frequency range | 158-175 | GHz |
| Instantaneous bandwidth | >10 | MHz |
| Switching Speed | >30 | kHz |
| Insertion Loss (ON-state) | <1 | dB |
| Return Loss (ON-state) | >20 | dB |
| Max Input Power, Pᵢₙ (OFF-state) | +17 | dBm |
| Max Output Power, Pₒᵤₜ (OFF-state) | −10 | dBm |
| Isolation (OFF-state, Pᵢₙ = +17 dBm) | >30 | dB |

More details of the design of frequency doubler chips for this example are provided in [18]. The chip incorporates an anti-series configuration of four planar Schottky diodes, integrated within a passive suspended microstrip circuit on a 5 μm-thick GaAs membrane. This membrane is mechanically and electrically interfaced with a split waveguide block through metallic beam leads. Key relevant diode parameters used for circuit modeling are summarized in Table II.

TABLE II
KEY DIODE PARAMETERS USED
IN THE CIRCUIT MODELLING

| Parameter | Value | |
|---|---|---|
| Saturation current, Iₛₐₜ | 4.45 · 10⁻¹³ | A |
| Zero-bias junction capacitance, Cⱼₒ | 20 | fF |
| Ohmic resistance, Rₛ | 6 | Ω |
| Ideality factor, N | 1.18 | |
| Junction potential, Vⱼ | 0.8 | V |
| Energy gap, E_{g} | 1.43 | eV |

The switch is optimized and analyzed in Ansys Electronics Desktop (AEDT) 2023 R1, using the High-Frequency Structure Simulator (HFSS) for full-wave electromagnetic (EM) simulations in combination with Ansys Circuits and Keysight ADS for harmonic balance circuit simulations.

The design of the quadrature hybrid waveguide coupler is based on the principles presented in [17]. A larger number of branches results in more balanced and wideband performance but is constrained by the machinable aspect ratio. A balanced transmission to the two output waveguide branches is crucial for achieving a low insertion loss and high isolation. For this illustrative example, the coupler was designed for a standard WR-5.1 waveguide (a_{WG}=1.295 mm, b_{WG}=0.648 mm) and was fabricated using split-block technology. A five-branch design is chosen to maintain the aspect ratio below 4:1.

TABLE III
KEY GEOMETRICAL PARAMETERS

| Parameter | Value | | Parameter | Value | |
|---|---|---|---|---|---|
| bᵢₙ | 648 | μm | bₒᵤₜ | 341 | μm |
| bₛₜₑₚ | 472 | μm | lₛₜₑₚ | 630 | μm |
| dᵢₙ | 406 | μm | dₒᵤₜ | 935 | μm |
| a | 194 | μm | c | 229 | μm |
| s | 649 | μm | R_{fillet} | 270 | μm |
| a_{WG} | 1.295 | mm | h_{c} | 182 | μm |
| d_{bs}^{f1} | 140 | μm | d_{bs}^{2f1} | 270 | μm |

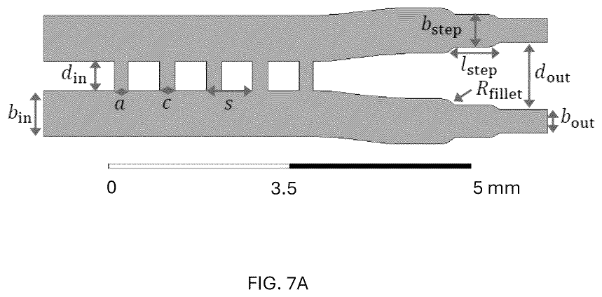

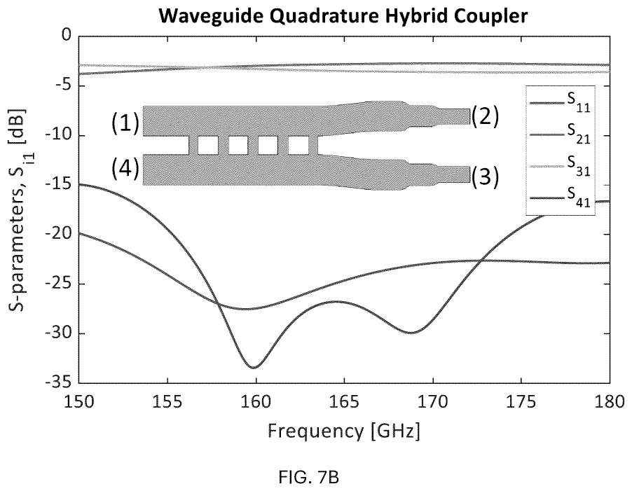

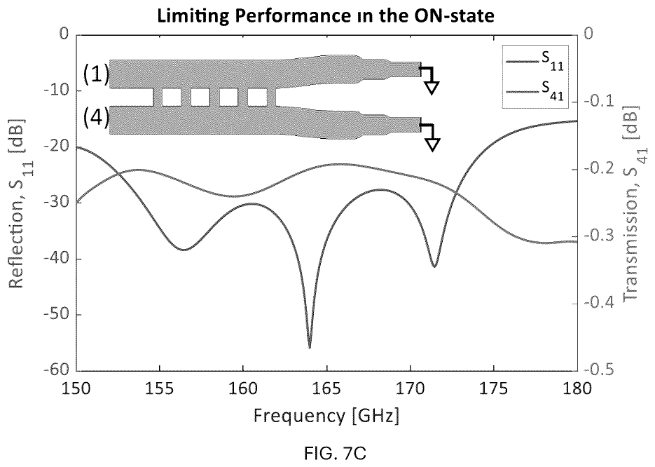

The final design is shown in FIG. 7A, with key geometrical parameters summarized in Table III. The final optimization includes a tapering section to increase the chip spacing (dₒᵤₜ) and a simple one-step transformer section to a reduced height waveguide (bₒᵤₜ). The chip spacing dₒᵤₜ was determined by the beam leads and the size of the 2ƒ₁ power-combining network.

The simulated S-parameters of the resulting network are shown in FIG. 7B. The amplitude imbalance, |S_{2, 1}-S_{3, 1}|, is kept below 0.9 dB. As a verification step for proper switch operation in the ON-state, ports #2 and #3 are terminated with a short, and the resulting simulated reflection and transmission parameters are shown in FIG. 7C. The transmission S_{4, 1} is between 0.2 dB and 0.3 dB, limited by ohmic losses. The wall conductivity is simulated as σ=2×10⁷ S/m.

The chip is designed for suspension in a reduced-height waveguide and termination with a backshort. The reduced-height waveguide was necessary to prohibit the propagation of the generated second harmonic field to the switch input and output ports. The backshort features a shallow cavity that is part of the suspended microstrip line, guiding the multiplied power to the 2ƒ₁ power combining network and test port. The second-harmonic EM field generated by the doubler circuit and redirected back to the input waveguide has a symmetry comparable to the TM₁₁ waveguide mode [18]. The reduced waveguide height, bₒᵤₜ, should therefore be chosen such that the maximum 2ƒ₁ frequency, i.e., 350 GHz in this example, remains below the TM₁₁ cutoff frequency

$${f}_{c}^{{TM}_{11}} = \frac{{c}_{0}}{2} \sqrt{{( \frac{1}{{a}_{WG}} )}^{2} + {( \frac{1}{{b}_{out}} )}^{2}} = 455 GHz \qquad ( 1 )$$

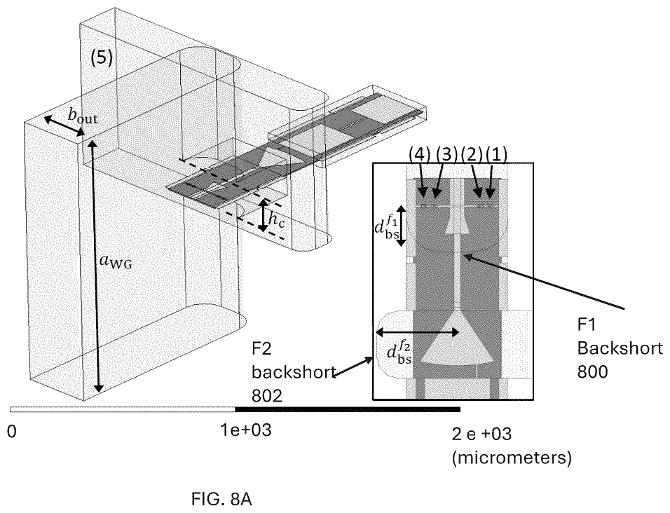

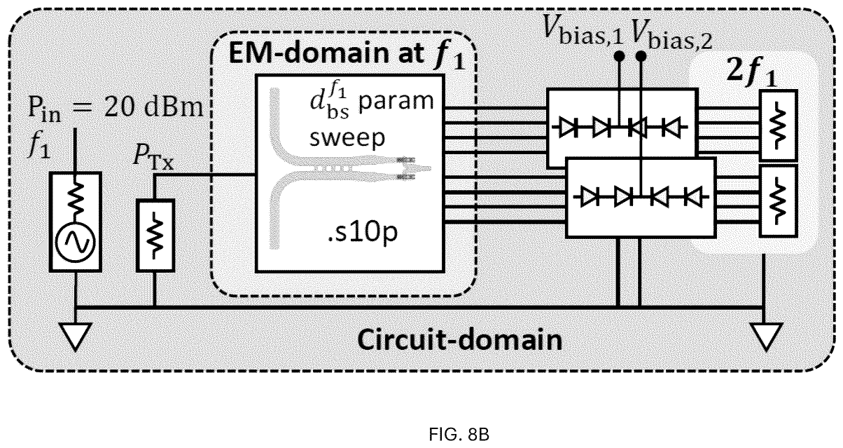

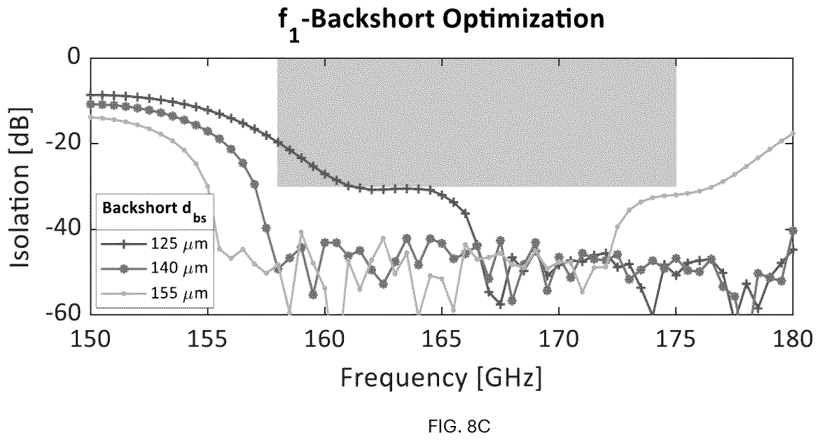

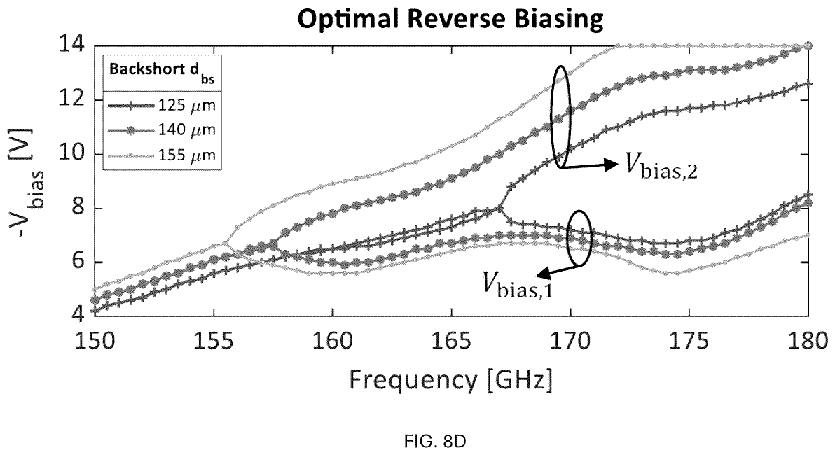

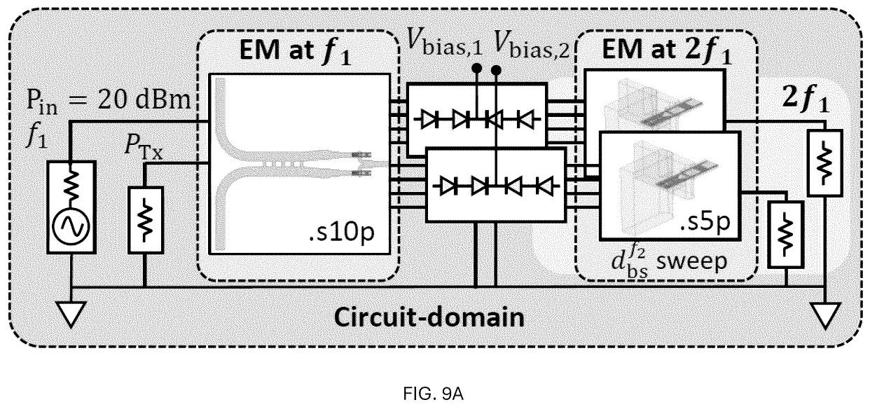

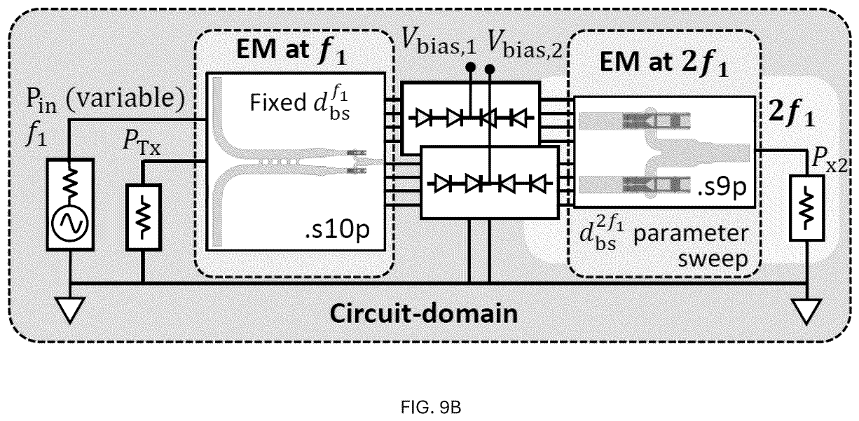

Similarly, the cavity height of the suspended microstrip in the backshort was selected to be only 182 μm (h_{c} in FIG. 8A), ensuring that the TE₁₀ mode at ƒ₁ remains comfortably in cutoff. The backshort distance, d^{ƒ}_{bs}, was optimized using an Ansys HFSS/Keysight ADS co-design, as illustrated in FIG. 8B. The co-design process utilizes the ƒ₁ EM model shown in FIG. 9A, which is simulated for various backshort distances. The exact geometrical details of the 2ƒ₁ power-combining waveguide network are not critical and can be omitted in the simulation since the field at ƒ₁ is in cutoff within the suspended microstrip cavity.

In the EM simulation, each Schottky anode is defined as a waveport, allowing the export of a 10-port S-parameter file (input, output, and eight Schottky anodes) from Ansys HFSS to Keysight ADS. The waveports are then connected to the circuit model of the chip. The circuit model can be defined using sinusoidal power sources, ideal filters, and DC-biasing connections, similar to FIG. 9.3 of [18]. In this optimization, power generated at the second harmonic is terminated in matched loads in the circuit model. In simulation, we verified that the backshort distance d^{ƒ}_{bs}¹ did not affect the launching efficiency of the second-harmonic field into the quasi-TEM suspended microstrip transmission line mode.

The backshort distance influences the impedance matching to the diode circuit, which is most critical in the OFF-state. The ON-state relies on maximizing the impedance mismatch and is therefore less affected by the backshort distance. Consequently, the optimization procedure maximizes isolation in the OFF-state for a high input power of Pᵢₙ=20 dBm as a function of frequency ƒ₁ and chip biasing voltages V_{bias, 1} and V_{bias, 2}. For each frequency point, the optimal chip biasing combination is determined to maximize isolation. The resulting isolation is shown in FIG. 8C for three different backshort distances, with the corresponding chip biasing voltages shown in FIG. 8D. The jittery isolation floor is the result of simulating only a discrete number of possible biasing voltages (in 200 mV steps) rather than a continuous voltage solution space.

A larger backshort distance shifts the isolation bandwidth to lower frequencies but also requires higher biasing voltages. A backshort distance of 140 micrometers was selected to shift the isolation knee just below 158 GHz while minimizing the required reverse-biasing voltage. The expected reverse breakdown voltage of two diodes in series is −17 V, and we limited the simulation to −14 V. The chips require the same biasing voltage up to a certain frequency, after which they require a different biasing voltage. As discussed herein, this indicates that the switch achieves its isolation by absorbing (or multiplying) the input power at lower frequencies, since any reflected power would be in-phase and transmitted to the output port. At higher frequencies, the chips require different biasing such that the reflected power is opposite in phase and reflected back to the (d) input port.

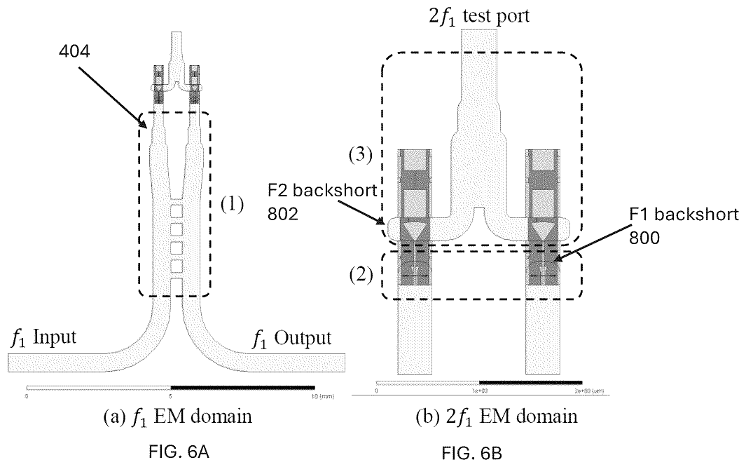

2f1-Backshort and Power Combiner: Proper handling of the power generated at the second harmonic is crucial, as it can in some embodiments exceed 20% of the input power. Reflections in the 2f1 waveguide network propagating back to the diodes can disrupt switching performance at f1. As shown in FIG. 6B, the power is launched by the on-chip probes into reduced-height waveguides and combined using an E-plane T-junction. The summed power can either be terminated in a load or, in this case, routed out for testing purposes.

The backshort distance in the 2f1 waveguide network, d2f1bs, is optimized in a similar manner as the f1-backshort. The simulation environment is illustrated in FIG. 9B. Instead

of terminating the second harmonic in a load, it is now fed into the five-port S-parameter blocks of the structure in FIG. 8A. This structure is simulated at 2f1 for various backshort distances. A backshort distance of d2f1bs=270 μm yielded results identical to the matched-load simulations in FIG. 8.

The T-junction and the waveguide transition to a standard WR-2.8 waveguide (711×356 μm) are optimized together using only full-wave EM simulations.

The final switch performance is then analyzed using the simulation environment depicted in FIG. 9B, where the 2ƒ₁ EM simulation domain corresponds to the waveguide network from FIG. 6B. The chip biasing points required to achieve maximum isolation depend on the input signal power level when Pᵢₙ>0 dBm. The switch performance is stable for input powers Pᵢₙ<0 dBm, where the frequency doubler chips are highly underpumped. In simulation, it is found that when the biasing points are optimized for an input power of 10 dBm, the switch offers an isolation better than 20 dB for any input.

### Fabrication and Assembly

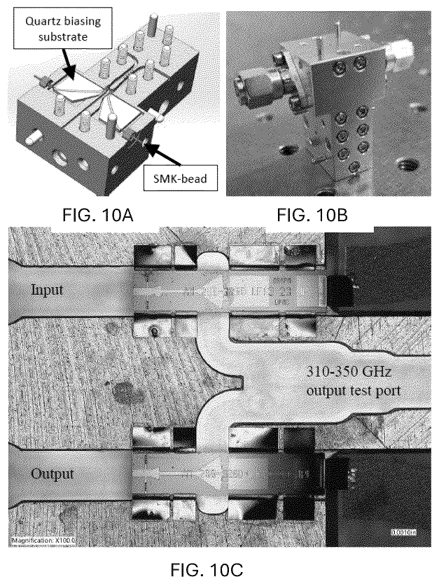

The switch was fabricated using split-block technology in gold-plated aluminum T6061. The CAD model, with the top split-block removed, is shown in FIG. 10A. A 508 μm-thick fused quartz substrate with a 600 μm-wide, 3 μm-thick gold trace is designed to route the biasing signals from SMK connectors to the chips. The biasing circuit and the diode chips do not have on-chip capacitors and are thus suitable for high-speed switching operations. A photograph of the fully assembled switch is shown in FIG. 10B, and a micrograph of the assembled chips is shown in FIG. 10C. The chips were connected to the biasing substrates via a ribbon bond. It can be worthwhile to screen and pre-select the chips before mounting them in the switch. The chips should be as balanced as possible for optimal performance. Typically, chips fabricated near each other should be chosen to minimize fabrication variations, and screening can be performed based on IV-curve probing measurements.

### Measurement Setup

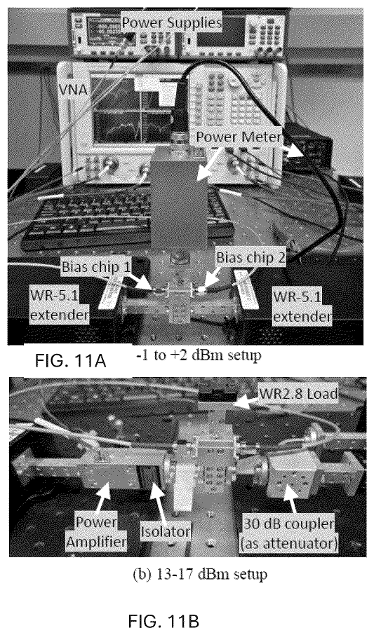

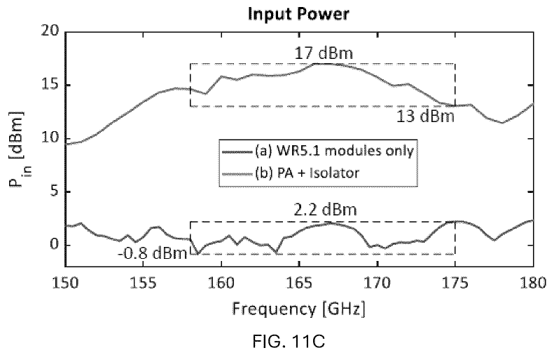

FIGS. 11A and 11B show two measurement setups used to characterize the switch at different input power levels. The setup FIG. 11A measured the switch response directly connected to VDI WR-5.1 frequency extenders in combination with a Keysight N5222A PNA Vector Network Analyzer (VNA). The chips were biased using Keithley 2280S-32-6 DC power supplies. When measuring the power at the second harmonic, a VDI Erickson PM5 power meter was used with a WR-2.8-WR10 waveguide transition, connected to the 2ƒ₁ test port. The power meter was also used to measure the power at the output of the extenders (i.e., the input power to the switch). The measured input power to the switch is shown in FIG. 11C and ranges from −0.8 dBm to 2.2 dBm.

The setup in FIG. 11B was used to characterize the switch under higher input power conditions, relevant for the OFF-state when the radar is transmitting. FIG. 11B shows a G-band power amplifier and isolator are driven by a frequency extender. The measured input power to the switch is also shown in FIG. 11C and ranges from 13 dBm to 17 dBm in the frequency range of interest.

### ON-State Measurements

The ON-state is relevant when the radar is not transmitting but receiving a scattered signal that is many orders of magnitude lower in power than the leakage signal in transmit mode. FIG. 12A shows measurements of the ON-state for Pᵢₙ≈0 dBm input power using the setup shown in FIG. 11A. It was verified that the switch performance was not affected when under pumping the frequency extenders to reduce the output power to lower levels.

The measured insertion loss and return loss are shown in FIG. 13 for a forward biasing voltage of V_{bias, 1&2}=1.6V. A higher biasing voltage improves the insertion loss due to an increased impedance mismatch, but the diode current was limited to 15 mA. The measured insertion loss was better than 0.86 dB and agrees well with the simulations. The limiting ohmic dissipation losses, shown as the thin curve for reference, are approximately 0.5 dB. This implies that approximately 0.36 dB of power was absorbed in the diodes due to their non-zero series resistance. The chips do not operate as frequency doublers in forward-bias mode. The return loss also agrees well with the simulation and remains below −26 dB up to 173 GHz.

### OFF-State Measurements

The OFF-state is relevant when the radar is transmitting, to protect the receiver LNA from being damaged by the leakage signal. Thet OFF-state measurements were reported for both measurement setups in FIGS. 11A and 11B, with an input signal power ranging from −0.8 dBm≤Pᵢₙ≤+17 dBm.

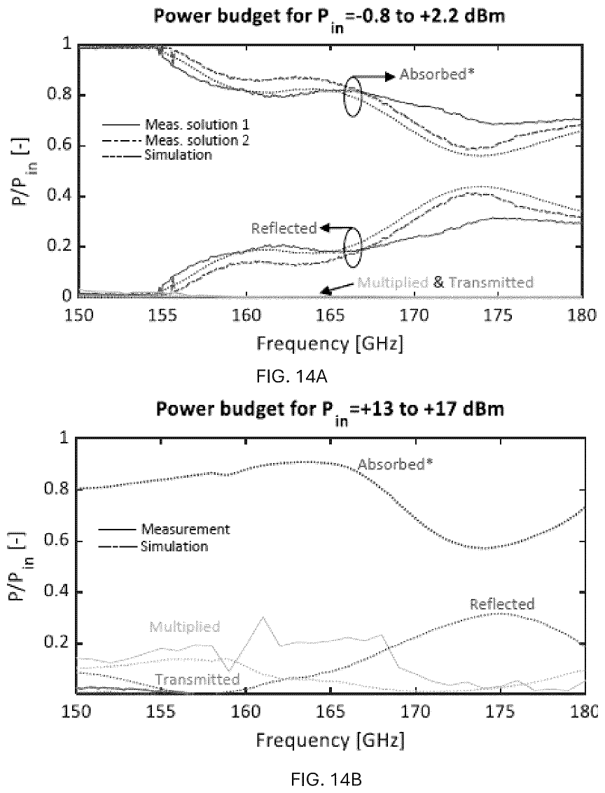

The measurement consisted of parameter sweeps of the chip reverse-bias voltages. For each biasing point, the VNA performed a frequency sweep, and the calibrated transmission S-parameters (and reflection parameter for the low-power setup) were recorded. After the measurement, the optimal chip biasing voltage combination was determined for each frequency point to maximize the isolation of the switch at that specific frequency. Thereafter, for a reduced number of frequency points, the optimal biasing conditions were applied, and the power meter was used to measure the power generated at the second harmonic. FIG. 13 shows the optimized isolation results and FIG. 14 shows the associated power budget. In the power budget, the absorbed power is derived from the reflected, multiplied, and transmitted power, assuming power conservation.

The results are as follows for two different input powers.

Pᵢₙ≈0 dBm: The measured and simulated OFF-state results for the setup shown in FIG. 11A are summarized on the left-hand side (LHS) of FIG. 13. The optimized biasing voltages and isolation are shown in FIGS. 11A and 11C, respectively. In the simulation, the optimal biasing voltage remains the same for both chips up to 155 GHz, after which the optimal biasing voltages begin to diverge.

The power budget in FIG. 14A shows that up to 155 GHz, the switch achieves isolation primarily through power absorption. Beyond this frequency, the switch also becomes reflective. To ensure that the reflected power is directed back to the input port rather than the output port, the reflection coefficients at the two hybrid branch terminations must be opposite in phase. In the simulation, the chips are assumed to be identical and perfectly balanced; thus, the chip biasing voltage combinations required to achieve this 180° phase difference are interchangeable. However, in practice, perfect balance is not achieved and each chip needs a different biasing voltage to produce the same phase shift. As seen in the LHS of FIG. 13A, the chips require different biasing voltages below 155 GHz to achieve the optimal impedance match for maximum absorption, demonstrating that there is no perfect balance. For frequencies above 155 GHz, when the switch also becomes reflective, two distinct, non-interchangeable biasing solutions exist to satisfy the opposite-phase reflection condition. Referring to FIG. 3D, one solution will correspond to Γ_{Q}=Γ₁+π whereas the other solution corresponds to Γ_{Q}=/Γ₁−π. It is also observed that the optimal measured bias voltage is significantly lower than predicted by the nominal simulation. This discrepancy is reproduced in simulation by varying the zero-bias junction capacitance Cⱼ₀ and the ohmic resistance Rₛ, as well as by introducing an imbalance between the two chips. Simulated junction capacitances of Cⱼ₀=18 fF for chip 1 and 16 fF for chip 2, along with a resistance of Rₛ=120/Cⱼ₀, yields bias voltages consistent with the measurements while maintaining good isolation performance. A change in the (parasitic) resistance or capacitance parameters of the diode model results in different bias voltages required to achieve the same RF impedance.

The measured isolation exceeds −43 dB across the bandwidth of interest and aligns well with the simulation. The instantaneous isolation, i.e., the isolation as a function of frequency for a fixed biasing condition, is shown in FIG. 13E for five frequency settings. No significant differences are observed between the two biasing solutions, and an excellent agreement with the simulations is noted. The instantaneous isolation bandwidth, i.e., the RF bandwidth over which the isolation remains better than a specified isolation threshold under a fixed biasing condition, is shown in FIG. 13G for various isolation levels. Under the strictest isolation requirement of −30 dB, the measured instantaneous bandwidth ranges from 500 MHz to 5 GHz.

The power budget in FIG. 14A shows that the switch in this example does not operate in frequency doubler mode under these input power conditions. With only 1 mW of input power, the circuit cannot pump the eight diodes of the two frequency doubler chips, making the switch an underpumped, low conversion efficiency, frequency doubler device. The frequency doubler chips were originally optimized for 40 mW input power each. Instead, the switch primarily relies on signal absorption and reflection.
2) Pᵢₙ≈15 dBm: Using the setup from FIG. 11B, the switch was evaluated under higher input power conditions. The optimized biasing voltages, (instantaneous) isolation, and instantaneous bandwidth are shown on the right-hand side (RHS) of FIG. 13, while the power budget is presented in FIG. 14B. The reflected power was not measured.

The knee in isolation in FIG. 13D shifts up in frequency to 158 GHz, both in measurement and simulation. Simulations indicate that below this frequency, the switch predominantly absorbs power while also operating as a frequency doubler with a power conversion efficiency of 12-14%. Above 158 GHz, the simulated doubler efficiency begins to decrease, and the switch becomes reflective. However, the measurements show increased jagged (but reproducible) behavior between 157 and 165 GHz. Without being bound by a scientific theory, we speculate that some of the jaggedness may result from the presence of second harmonic content in the transmitted signal. A significant second harmonic component can occur if the diodes or chips are not assembled perfectly symmetrically within the waveguides. In such a case, the second harmonic field could leak into the switch via a TE mode rather than the TM₁₁ mode, which is in cutoff. The second harmonic signal could potentially be remixed in the frequency extension heads, subsequently modulating the fundamental signal. The spectrally fine fluctuating features visible in the instantaneous isolation, shown in FIG. 11F, support this hypothesis, although additional study and measurements are needed for confirmation. Despite this behavior, the overall isolation remains below −30 dB. The instantaneous bandwidth required to meet a given isolation threshold remains above 200 MHz for the strictest −30 dB isolation requirement at frequencies above 157 GHz. The measured multiplied power in FIG. 11(b) confirms that the switch operates as a frequency doubler with a measured power conversion efficiency exceeding 20%.

### High-Speed Switching Measurement

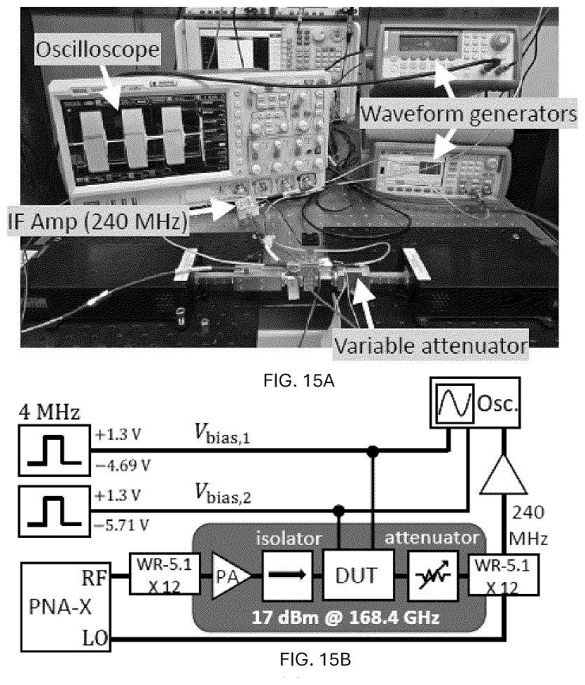

The switch was characterized at an ultra-fast 4 MHz switching rate using the measurement setup shown in FIG. 15. This setup is a variation of the high-power measurement setup shown in FIG. 11B, where the power supplies are replaced by two waveform generators. Additionally, the measured intermediate frequency (IF) output of the VDI WR-5.1 Rx frequency extender is not connected to the VNA but is instead amplified and fed into an oscilloscope. The waveform generators produce synchronized 4 MHz square waves to alternately bias the switch in its ON and OFF states. The switch was tested at a fixed RF frequency of 168.4 GHz, where the input power is approximately at its maximum (+17 dBm).

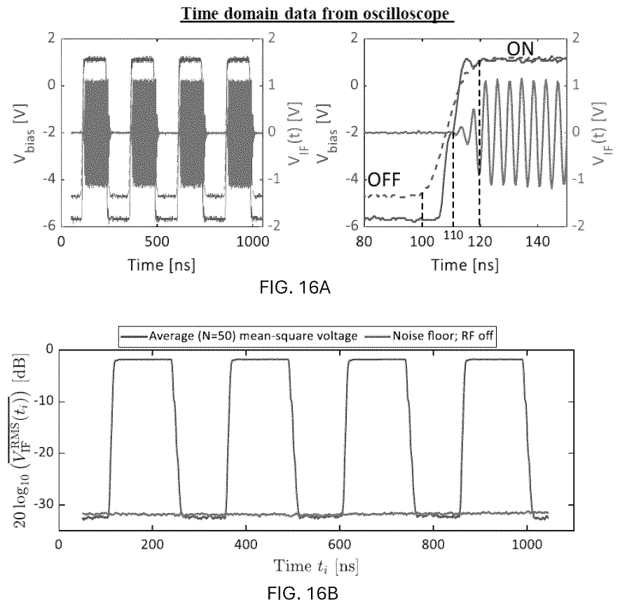

A 1-μs recorded time stream of the bias signals (V_{bias}) and IF signal (I_{IF}(t)) is shown on the LHS of FIG. 16A. The RHS shows a zoom-in of an OFF-to-ON-state transition. It can be seen that the waveform generators do not produce perfect square waves, and it takes approximately 20 ns for the biasing signals to settle. The apparent switching delay of 5-10 ns is mostly attributed to the imperfect square waves and the time required for the signals to propagate through the extender and IF cables. For example, the estimated 1.5 m propagation distance corresponds to approximately 5 ns at the speed of light. The actual switching speed is expected to be sub-nanosecond.

The average power flow through the switch is calculated to investigate switch isolation. First, the root-mean-square (RMS) IF voltage is computed for each recorded timestamp tᵢ over a full period of the signal, Δt=1/240 MHz=4.2 ns, using (2a). The oscilloscope sampling rate is 10 GSa/s, so each RMS calculation includes 42 data points. Secondly, the RMS IF signal is averaged over M=50 measurements to reduce setup noise, as expressed in (2b):

$${V}_{IF , m}^{RMS} ( {t}_{i} ) = \sqrt{{\frac{1}{Δ t} {\int }_{{t}_{i}}^{{t}_{i} + Δ t} \vert {V}_{IF , m} ( t ) \vert}^{2} dt} \qquad ( 2 a )$$

$$\overline{{V}_{IF}^{RMS} ( {t}_{i} )} = \frac{1}{M} {\sum }_{m = 1}^{M} {V}_{IF , m}^{RMS} ( {t}_{i} ) \qquad ( 2 b )$$

The average power flow is then proportional to the square of the averaged RMS IF signal. and the result is shown in FIG. 16B. The figure also includes a noise floor measurement obtained by turning off the RF power of the VNA. An isolation of more than 30 dB is demonstrated at a 4 MHz switching rate, limited by the noise floor of the setup.

### Process Steps

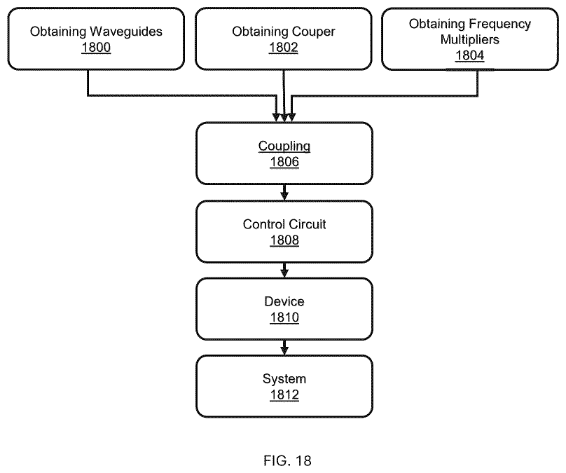

FIG. 18 is a flowchart illustrating a method of making a switch comprising the following steps.

Block 1800 represents fabricating or obtaining a set of waveguides comprising at least a first and second waveguide, and optionally a Y junction or output waveguide for coupling the higher harmonic outputs of the frequency multipliers to a load (for absorbing the higher harmonics) or test output. In some embodiments, the waveguides are formed in a metal block (e.g., split block, where half or a first portion of each waveguide is milled in one block, the other half or complementary portion of each waveguide is in a second block, and assembly of the complementary blocks forms the waveguides. The switch does have low RF losses because it does use a metallic waveguide structure (hollow rectangular pipe). In other embodiments, the switch or waveguides can be made out of plastic, 3D printed or molded, but the inside of the waveguides must be metalized (gold, copper, silver, aluminum) with a very good surface finish to have low waveguide losses. It is possible also to make the waveguide structure in silicon but it must be metalized too, see [21]. While the switch could be implemented in silicon waveguides, silicon micromachined waveguides may be a good solution for higher frequencies where waveguides will be smaller.

Block 1802 represents fabricating or obtaining a coupler, e.g., in the same or different platform (e.g., metal block) as the waveguides in Block 1800.

Block 1804 represents fabricating or obtaining frequency multipliers, e.g., typically in semiconductor chips, e.g., GaAs, GaN, e.g. GaAs diodes on GaAs substrates high-thermal conductivity substrates like Aluminum Nitride (AlN) or Diamond. Gallium Nitride (GaN) Schottky diodes, with much higher breakdown voltages than their Gallium Arsenide counterparts, could also be used.

Block 1806 represents coupling the frequency multipliers to the set of waveguides and the coupler.

Block 1808 represents coupling a control circuit to the frequency multipliers, e.g., for applying the biasing DC1, DC2, V1, V2 to the diodes.

Block 1810 represents the end result, a device useful as a switch.

Block 1812 represents optionally coupling the device in a system, e.g., RADAR system e.g., but not limited to, for image generation in a navigation system for a vehicle, industrial quality control application, or security screening application, or remote sensing (e.g., climate monitoring, atmospheric monitoring, cloud imaging, radiometric applications) or in a backhaul of a communication network.

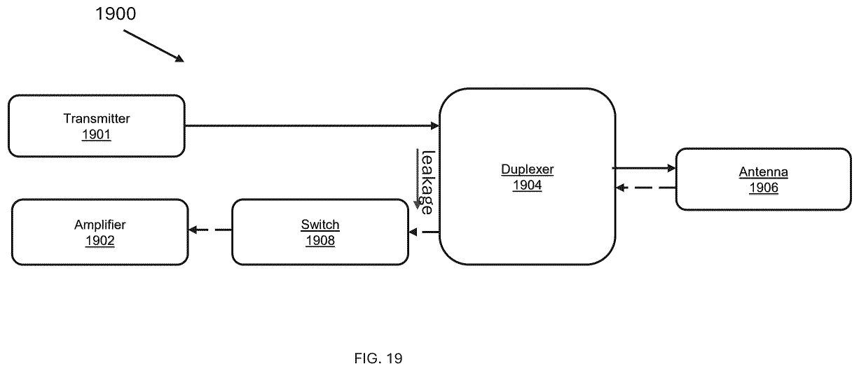

The switch can be embodied in many ways including, but not limited to, the following (referring also to FIGS. 1-18).
1. A switch 200 or device 200 useful as a switch, comprising:
a first waveguide 201 and a second waveguide 210 integrated with means for frequency multiplying (e.g., frequency multipliers 208), wherein:
the waveguides are coupled to a means for coupling (e.g., coupler 202) comprising:
a first branch 203 comprising a section of the first waveguide 201 coupled in a coupling region 205 to a second branch 207 comprising a section of the second waveguide 210, wherein the first waveguide 201 comprises an input port 401 and a first termination 211, the second waveguide 210 comprises an output port 402 and a second termination 212, and the coupling region is between the terminations and the ports; and
the frequency multipliers 208, configured to frequency multiply a signal to suppress transmission of the signal between the input port and the output port of the switch in an off state, comprise:
at least one first frequency multiplier 208a integrated with the first waveguide 201 at the first termination 211; and
at least one second frequency multiplier 208b integrated with the second waveguide 210 at the second termination 212.
2. The device of clause 1, wherein the frequency multipliers each comprise a frequency doubler operable to generate a second harmonic of a signal inputted to the input port.
3. The device of clause 1 or 2, wherein the frequency multipliers each comprise one or more diodes (e.g., Schottky diodes D1-D4).
4. The device of clause 3, wherein the diodes are operable to switch the device to an on state when forward biased and operable to switch the device to an off state when reverse biased, wherein:
in the on state, reflection coefficients I for the signal inputted to the input port and received at the terminations are maximized (e.g., 1 or close to 1) and in phase to minimize insertion loss and maximize transmission of the signal to the output port; and
in the off state, the reflection coefficients at the terminations are equal in amplitude and out of phase by 180 degrees so that the signal is (1) reflected back to the input port, (2) absorbed in the diodes, or (3) multiplied to a higher frequency harmonic by the diodes.
5. The device of any of the clauses 1-4, wherein:
the first frequency multiplier 208a comprises a first microstrip circuit 214 comprising at least one first diode D1 on a first semiconductor membrane 216 that is suspended in the first waveguide; and
the second frequency multiplier 208b comprises a second microstrip circuit 214 comprising at least one second diode DI on a second semiconductor membrane 216; and
the waveguides are formed in a split block of metal 230.
6. The device of any of the clauses 2-5, wherein the at least first diode and the at least second diode are balanced to optimize efficiency of the harmonic generation by the frequency multipliers.
7. The device of any of the clauses 1-6, wherein the coupling region comprises a plurality of branches 232 connecting the first waveguide and the second waveguide to achieve a balanced transmission of the signal, received at the input port, to the first termination and the second termination.
8. The device of any of the clauses 1-7, wherein each of the waveguides comprises:
a taper 404 to increase a spacing S between the waveguides along a direction from the coupling region to the terminations;
a section reducing the height (hc in FIG. 8A) of the waveguides 201, 210 to a reduced height at the terminations that suppresses back-transmission or coupling of higher harmonics of the signal from the frequency multipliers back into the waveguides towards the ports; and
a backshort (e.g., 800 in FIG. 8A, e.g., conductive wall) at an end of the waveguide 201, 210 for reflecting a non-multiplied portion of the signal back to the frequency multiplier.
9. The device of any of the clauses 1-8, further comprising:
a waveguide junction (270 in FIG. 2A or FIG. 4B) connected to the waveguides at a position to combine higher harmonic outputs from the frequency multipliers to a load or a test output 272; and
a higher harmonic backshort (e.g., 802 in FIG. 8A) positioned for reflecting the higher harmonic outputs towards the test output or the load for absorbing the higher harmonics.
10. The device of any of the clauses 1-9, wherein at least one of the backshort positioning (e.g., d^{f1}bs and d^{f2}bs in FIG. 8A), the biasing V1, V2, DC1, DC2 of the diodes, balancing of the diodes for harmonic generation, number of branches 232 coupling the waveguides in the coupling region, and dimensions of the waveguides are configured for:
in the on state of the switch, coupling a radar signal from an antenna 1906 to an amplifier 1902 when the antenna is coupled to the input port and the amplifier is connected to the output port; and
in the off state of the switch, isolating a transmit signal from the amplifier when the transmit signal is outputted from a radar transmitter 1901 to the antenna and leaks to the input port.
11. FIG. 19 illustrates a RADAR system 1900 comprising the device 200 of clauses 1-10 and further comprising:
a duplexer 1904 having a first input, a second input, and an output;
a transmitter 1901 connected to the first input;
an amplifier 1902 connected to the second input;
an antenna 1906 connected to the output of the duplexer; and
the input port of the switch 1908 comprising the device 200 connected to the second input of the duplexer and the amplifier connected to the output port of the switch.
12. The device of any of the clauses 1-11, wherein the signal comprises a G band frequency or a frequency in a range of 100-300 GHz and the waveguides (e.g., WR 5.1) and coupler are dimensioned (e.g., width) and otherwise configured for transmission of those frequencies, and the frequency multipliers are configured for frequency multiplying those frequencies.
13. The device of any of the clauses 1-12, wherein the signal transmitted from the input port to the output port in an on state of the switch has a frequency between 100 GHz and 500 THz.
14. The device of any of the clauses 10-13 configured for at least +20 dBm input power of the signal with less than 1.5 dB insertion loss in the on state, <−30 dB isolation between the input port and the output port in the off state, and a switching speed of at least 1 MHz between the off state and the on state.
15. The device of any of the clauses 1-14, wherein the coupler is a quadrature hybrid coupler.
16. The device of any of the clauses 1-15, wherein the at least one first frequency multiplier is formed in a first semiconductor chip 204 suspended in the first waveguide 201 at the first termination and the at least one second frequency multiplier is formed in a second semiconductor chip 204 suspended in the second waveguide 210 at the second termination.
17. The device of any of the clauses 1-16, wherein the waveguides are formed in a metal block 230.
18. A device useful as a switch, comprising:
an input waveguide 201 coupled to an output waveguide 210;
a first diode circuit 206 (e.g., in chip 204) integrated with the input waveguide 201 at a first termination;
a second diode circuit 206 (e.g., in chip 204) integrated with the output waveguide 210 at a second termination; wherein the biasing DC1, DC2 the diode circuits switches the switch between an off state and an on state and achieves high isolation in the off state by absorbing input power in, reflecting the input power from, and frequency multiplying the input power using, diodes D1 in the diode circuits 206.
19. The device clause 18 comprising the any of the features of clauses 2-17.
20. The device of clause 18 or 19 or any of the clauses 1-17, wherein the diodes (e.g., Schottky diodes) are balanced or symmetrically configured, such that each diode should be as identical as possible in terms of size, electrical characteristics, and operating conditions e.g., same Forward voltage, capacitance (which affects the diode's frequency response), and I-V characteristics (the current-voltage curve) so as to minimize unequal current flow through the diodes, affecting their efficiency and the harmonic output, and/or biasing of the diodes at each of the terminations are independently adjusted to mitigate for imperfect balancing.
21. The device of clause 20, wherein the diodes are balanced and/or biased for the frequency of the signal and power of the signal used in an application, in the on state, reflection coefficients for the signal inputted to the input port and received at the terminations are maximized and in phase to minimize insertion loss, minimize on state resistance, and maximize transmission of the signal to the output port; and in the off state, the reflection coefficients at the terminations are equal in amplitude and out of phase by 180 degrees so that the signal is (1) reflected back to the input port, and/or (2) absorbed in the diodes, and/or (3) multiplied to a higher frequency harmonic by the diodes (e.g., reflected, absorbed, and multiplied, or at least one of reflected, absorbed, or multiplied, or at least two of reflected, absorbed or multiplied).
22. A method of operating a RADAR comprising the switch of any of the clauses 1-21, further comprising switching between an on state wherein the signal from the antenna is transmitted through the switch to an amplifier for the signal for measurement of the signal received at the antenna, and an off state of the switch wherein the transmitted signal generated in a transmitter and transmitted through a duplexer to the antenna for transmission from the antenna, is blocked from leaking to the amplifier by the switch.
23. A method of operating a RADAR system of any of the clauses 1-22, comprising:
switching a connection between an antenna and a transmitter or an amplifier using a switch, wherein:
a signal is transmitted from the antenna to the amplifier in an on state of the switch and a transmit signal transmitted from a transmitter is isolated from the amplifier in an off state of the switch, and
the switch comprises frequency multipliers using frequency multiplication of the transmit signal to isolate the amplifier in the off state.
24. One or more chips, comprising:
one or more pairs of frequency multipliers, each of the frequency multipliers comprising an integrated circuit comprising (e.g., Schottky) diodes having inputs for coupling to a waveguide connected to a coupler in a switch, and each of the frequency multipliers configured and balanced to frequency multiply a signal so as to suppress transmission of the signal between an input port and an output port of the switch in an off state.
25, The chips of clause 24, further configured according to any of the clauses 1-22.
26. The device or chips of any of the clauses 1-25, wherein the switch is a RF (radio frequency) switch or G-band RF switch.
27. The device or chips of any of the clauses 1-26, optimized for 158 to 175 GHz, achieves high isolation by absorbing, reflecting, and frequency multiplying the input power to the 2^{nd} harmonic with an ON-state insertion loss <0.86 dB, return loss >20 dB at 0 dBm input power, OFF-state isolation exceeding 43 dB at 0 dBm input power and remains above 30 dB at +17 dBm input power.

### Advantages and Improvements

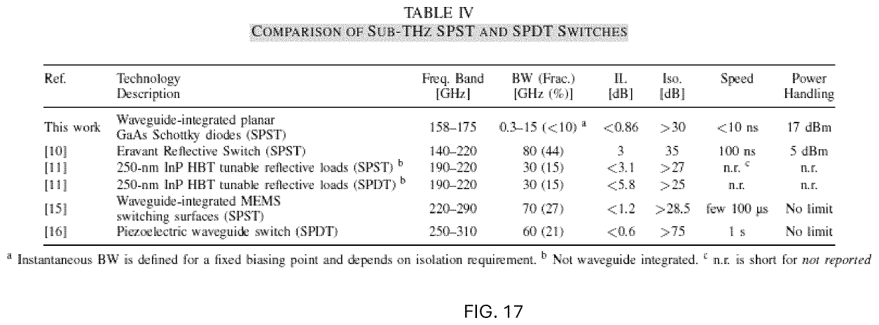

The performance of the switch is summarized in Table IV in FIG. 17 together with comparable sub-THz switches found in the literature. It can be seen that the electromechanical switches in [15] and [16] exhibit high performance but cannot reach a switching speed of a few microseconds. The solid-state switches in [11] and [10] have higher insertion loss and cannot handle high input powers. The switching based on the GaAs Schottky diode chips described herein shows good and fast switching performance for high input power, and is ideal for radar receiver protection where the required instantaneous bandwidth is limited.

This G-band switch was designed around existing devices intended for a 260-320 GHz medium power frequency doubler. Optimizing the Schottky diode balanced doubler circuit specifically for a low-loss switch is expected to yield better performance. In particular, the focus should be put on lowering the resistance of the diodes to lower the ON-state losses of the switch. For low-power applications, up to an estimated 20 mW, chips with only two diodes should bring optimum performance. Much higher power designs necessitate more than 4 diodes per device and can be implemented on thicker GaAs substrates or reported on high-thermal conductivity substrates like Aluminum Nitride (AlN) or Diamond. Gallium Nitride (GaN) Schottky diodes, with much higher breakdown voltages than their Gallium Arsenide counterparts, should ultimately lead to better power handling and high performance, provided that their series resistance is low enough to be competitive with an array of GaAs diodes in series. The instantaneous bandwidth of the G-band switch could also be increased through optimization to several gigahertz, which is needed for radiometric applications.

### Application to Atmospheric Radars

Atmospheric radars at G-band are powerful instruments for the vertical profiling of clouds, precipitation, and humidity [1], [2], [3]. Successful ground-based [1] and airborne observations [2] have been demonstrated with the Vapor In-cloud Profiling Radar (VIPR). VIPR is a differential absorption radar (DAR) operating around 170 GHz and developed at NASA's Jet Propulsion Laboratory (JPL). Deploying space-borne atmospheric radars into low-Earth orbit (LEO) could provide global mapping of the vertical structure of clouds and precipitation [4], [5]. Moving toward this goal, a G-band Doppler radar prototypeat 238.8 GHz [6] for CloudCube, a multi-frequency (Ka, W-, and G-band) atmospheric radar under development. For a space-borne implementation of G-band radars, much higher transmit powers will be required compared to ground or airborne measurements. As this power approaches tens to hundreds of Watts, receiver protection switches will be needed to prevent damage to delicate G-band low-noise amplifiers (LNAs).

Initial requirements for such a receiver protection switch are summarized in Table I. The requirements are derived from the coherent reflector array architecture proposed in [7], but the switch is highly relevant for any other high-power microwave/millimeter-wave radar. In [7], a 15-20 cm diameter reflector phased array element is presented, where the transmit and receive modules are isolated via a waveguide-based circularly-polarized orthomode transducer (OMT). The small size of the reflector element prohibits quasi-optical diplexing of the transmit (Tx) and receive (Rx) signals, which would otherwise provide isolation greater than 80 dB. Commercially available OMTs can provide isolation as high as 35 dB but introduce an insertion loss of 3 dB [8]. Septum-based OMTs have been demonstrated at 225 GHz with insertion losses below 1 dB and isolation better than 30 dB [9]. We envision transmitting approximately 15 W (≡42 dBm) while limiting the Tx-to-Rx leakage signal power to −10 dBm to avoid fatal damage to the sensitive receiver LNA. Given an OMT isolation of 25 to 30 dB, the required OFF-state isolation of the switch should be 30 dB for input powers as high as 17 dBm. In the ON-state, the insertion loss should be less than 1 dB. In the ON-state, the input power will be orders of magnitude lower.

Cloud radars must carefully time their transmit and receive windows to accommodate round-trip delays, the depth of the atmosphere being unambiguously probed, and duty cycle limitations of high-power transmitters. With these considerations, a switch speed requirement of <30 μs (>33 kHz rate) is a goal for our G-band diode switch. The DAR is tunable from 158.6 GHz to 174.8 GHz, defining the required operational bandwidth of the switch. The required instantaneous bandwidth is 10 MHz.

The insertion loss of traditional purely reflective solidstate switches is typically limited by their Rₒₙ resistance and/or the waveguide-to-chip interconnect required for our application. State-of-the-art reflective solid-state switches at Gband exhibit insertion losses greater than 2 dB and are rated for input powers up to +5 dBm [10], [11]. At submillimeter wavelengths, micro-electromechanical system (MEMS) waveguide switches operate up to 750 GHz [12], [13], [14], and this technology has evolved to achieve a low insertion loss of 0.7-1.2 dB and high isolation of 30 dB in the sub-THz range [15]. However, the expected switching speed reported in [15] is a few hundred microseconds, which is insufficient for this radar application. Similarly, electromechanically actuated waveguide switches demonstrate state-of-the-art performance in terms of insertion loss and isolation [16] but also fail to meet the switching speed recommendation. A low-loss, high isolation solid-state switch is therefore desired, which is the focus of this paper. The novel tunable solid-state switching architecture described herein based on planar Gallium Arsenide (GaAs) Schottky diodes is low loss and offers a switching time in the order of nanoseconds that can be used for the atmospheric or cloud radars described in the section, including but not limited to spaceborne or satellite borne (e.g., cubesat) radars.

### REFERENCES

The following references are incorporated by reference herein.
[1] K. B. Cooper, R. J. Roy, R. Dengler, R. R. Monje, M. Alonso-delPino, J. V. Siles, O. Yurduseven, C. Parashare, L. Millan, and M. Lebsock, “G-′ band radar for humidity and cloud remote sensing,” IEEE Transactions on Geoscience and Remote Sensing, vol. 59, no. 2, pp. 1106-1117, 2020.
[2] R. J. Roy, K. B. Cooper, M. Lebsock, J. V. Siles, L. Millan, R. Dengler, R. R. Monje, S. L. Durden, F. Cannon, and A. Wilson, “First airborne measurements with a G-band differential absorption radar,” IEEE Transactions on Geoscience and Remote Sensing, vol. 60, pp. 1-15, 2022.
[3] B. M. Courtier, A. Battaglia, P. G. Huggard, C. Westbrook, K. Mroz, R. S. Dhillon, C. J. Walden, G. Howells, H. Wang, B. N. Ellison, et al., “First observations of G-band radar Doppler spectra,” Geophysical Research Letters, vol. 49, no. 4, p. e2021GL096475, 2022.
[4] S. Tanelli, Z. S. Haddad, E. Im, S. L. Durden, O. O. Sy, E. Peral, G. A. Sadowy, and M. Sanchez-Barbetty, “Radar concepts for the next generation of spaceborne observations of cloud and precipitation processes,” in 2018 IEEE Radar Conference (RadarConf18), 2018, pp. 1245-1249.
[5] A. Battaglia, P. Kollias, R. Dhillon, R. Roy, S. Tanelli, K. Lamer, M. Grecu, M. Lebsock, D. Watters, K. Mroz, G. Heymsfield, L. Li, and K. Furukawa, “Spaceborne cloud and precipitation radars: Status, challenges, and ways forward,” Reviews of Geophysics, vol. 58, no. 3, p. e2019RG000686, 2020, e2019RG000686 10.1029/2019RG000686. [Online]. Available: HTTP//agupubs.onlinelibrary.wiley.com/doi/abs/10.1029/2019RG000686
[6] J. M. Socuellamos, R. Rodriguez Monje, K. B. Cooper, M. D. Lebsock, S. P. M. Nagaraja, J. V. Siles, R. M. Beauchamp, and S. Tanelli, “A G-band Doppler radar for atmospheric profiling,” IEEE Transactions on Geoscience and Remote Sensing, vol. 62, pp. 1-8, 2024.
[7] A. Maestrini, K. Cooper, S. van Berkel, M. Lebsock, C. Lee, G. Chattopadhyay, and I. Mehdi, “Reflector-based phased array for high power G-band radars,” in 2022 32nd IEEE International Symposium on Space Terahertz Technology (ISSTT). Baeza, Spain: IEEE, Oct 2022, p. 1.
[8] Eravant. (2025) G-band orthomode transducer. [Online]. Available: https://www.eravant.com/140-to-220-ghz-30-db-iso-0-051-x-0-051-sq-wg-ant-port-g-band-orthomode-transducer
[9] C. A. Leal-Sevillano, K. B. Cooper, J. A. Ruiz-Cruz, J. R. MontejoGarai, and J. M. Rebollar, “A 225 GHz circular polarization waveguide duplexer based on a septum orthomode transducer polarizer,” IEEE Transactions on Terahertz Science and Technology, vol. 3, no. 5, pp. 574-583, 2013.
[10] Eravant. (2025) Reflective SPST switch. [Online]. Available: https://www.eravant.com/140-to-220-ghz-35-db-isolation-wr-05connector-reflective-spst-switch, Accessedon
[11] J. S.-C. Chien and J. F. Buckwalter, “Low insertion loss, reflectiveload switches operating in D-band and G-band,” IEEE Transactions on Microwave Theory and Techniques, vol. 71, no. 1, pp. 230-239, 2022.
[12] T. Reck, C. Jung-Kubiak, and G. Chattopadhyay, “A 700-GHz MEMS waveguide switch,” IEEE Transactions on Terahertz Science and Technology, vol. 6, no. 4, pp. 641-643, 2016.
[13] U. Shah, T. Reck, H. Frid, C. Jung-Kubiak, G. Chattopadhyay, I. Mehdi, and J. Oberhammer, “A 500-750 GHz RF MEMS waveguide switch,” IEEE Transactions on Terahertz Science and Technology, vol. 7, no. 3, pp. 326-334, 2017.
[14] S. Rahiminejad, S. van Berkel, R. Lin, S. Khanal, C. Jung-Kubiak, G. Chattopadhyay, and M. Rais-Zadeh, “500-750 GHz contactless rotating MEMS single-pole double-throw waveguide switch,” Journal of Microelectromechanical Systems, vol. 33, no. 5, pp. 532-542, 2024.
[15] Karimi, U. Shah, S. Yu, and J. Oberhammer, “A high-performance 220-290 GHz micromachined waveguide switch based on interference between MEMS reconfigurable surfaces,” IEEE Transactions on Terahertz Science and Technology, vol. 14, no. 2, pp. 188-198, 2024.
[16] S. van Berkel, S. Rahiminejad, R. Lin, and G. Chattopadhyay, “A 250-310 GHz piezo-motor actuated SPDT waveguide switch with high isolation,” IEEE Transactions on Terahertz Science and Technology, vol. 13, no. 2, pp. 158-166, 2022.
[17] J. Reed, “The multiple branch waveguide coupler,” IRE Transactions on Microwave Theory and Techniques, vol. 6, no. 4, pp. 398-403, 1958.
[18] Maestrini and J. V. Siles, “Signal generation by diode frequency multiplication,” Fundamentals of Terahertz Devices and Applications, pp. 323-381, 2021.
[19] D. M. Pozar, Microwave engineering: theory and techniques. John wiley & sons, 2021.
[20] Ultra-fast Low-Loss SPST Switch using Planar GaAs Diodes for G-band Radar Receiver Protection by Sven van Berkel; Alain Maestrini; Robert Lin; Choonsup Lee; Goutam Chattopadhyay; Raquel Rodriguez Monje, IEEE Transactions on Terahertz Science and Technology (Early Access) Page(s): 1-12, July 2025, DOI: 10.1109/TTHZ.2025.3588046
[21] C. Jung-Kubiak et al., “A Multistep DRIE Process for Complex Terahertz Waveguide Components,” in IEEE Transactions on Terahertz Science and Technology, vol. 6, no. 5, pp. 690-695, September 2016, doi: 10.1109/TTHZ.2016.2593793. keywords: {Silicon; Metals; Etching; Waveguide components; Loss measurement; Resists; Deep reactive-ion etching (DRIE); orthomode transducer (OMT); silicon dioxide (SiO2); silicon micromachining; submillimeter waves; terahertz (THz).

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A device useful as a switch, comprising:
a first waveguide and a second waveguide integrated with frequency multipliers, wherein:
the waveguides are coupled to a coupler comprising:
a first branch comprising a section of the first waveguide coupled in a coupling region to a second branch comprising a section of the second waveguide, wherein the first waveguide comprises an input port and a first termination, the second waveguide comprises an output port and a second termination, and the coupling region is between the terminations and the ports; and
the frequency multipliers, configured to frequency multiply a signal to suppress transmission of the signal between the input port and the output port of the switch in an off state, comprise:
at least one first frequency multiplier integrated with the first waveguide at the first termination; and
at least one second frequency multiplier integrated with the second waveguide at the second termination.

2. The device of claim 1, wherein the frequency multipliers each comprise a frequency doubler operable to generate a second harmonic of a signal inputted to the input port.

3. The device of claim 2, wherein the frequency multipliers each comprise one or more Schottky diodes.

4. The device of claim 3, further comprising a control circuit operable to forward bias the diodes to switch the device to an on state and reverse bias the diodes to switch the device to an off state, wherein:
in the on state, reflection coefficients for the signal inputted to the input port and received at the terminations are maximized and in phase to minimize insertion loss and maximize transmission of the signal to the output port; and
in the off state, the reflection coefficients at the terminations are equal in amplitude and out of phase by 180 degrees so that the signal is (1) reflected back to the input port, (2) absorbed in the diodes, or (3) multiplied to a higher frequency harmonic by the diodes.

5. The device of claim 1, wherein:
the first frequency multiplier comprises a first microstrip circuit comprising at least one first diode on a first semiconductor membrane that is suspended in the first waveguide; and
the second frequency multiplier comprises a second microstrip circuit comprising at least one second diode on a second semiconductor membrane; and
the waveguides are formed in a split block of metal.

6. The device of claim 5, wherein the at least first diode and the at least second diode are balanced to optimize efficiency of harmonic generation by the frequency multipliers.

7. The device of claim 1, wherein the coupling region comprises a plurality of branches connecting the first waveguide and the second waveguide to achieve a balanced transmission of the signal, received at the input port, to the first termination and the second termination.

8. The device of claim 1, wherein each of the waveguides comprises:
a taper to increase a spacing between the waveguides along a direction from the coupling region to the terminations;
a section reducing a height of the waveguide to a reduced height at the terminations that suppresses back-transmission or coupling of higher harmonies of the signal from the frequency multipliers back into the waveguide towards the ports, and
a backshort at an end of the waveguides for reflecting a non-multiplied portion of the signal back to the frequency multiplier.

9. The device of claim 8, further comprising:
a waveguide junction connected to the waveguides at a position to combine higher harmonic outputs from the frequency multipliers to a load or a test output; and
a higher harmonic backshort positioned for reflecting the higher harmonic outputs towards the test output or the load for absorbing the higher harmonics.

10. The device of claim 9, wherein at least one of the backshort positioning, biasing of the frequency multipliers comprising diodes, balancing of the diodes for harmonic generation, number of branches coupling the waveguides in the coupling region, and dimensions of the waveguides are configured for:
in the on state of the switch, coupling a radar signal from an antenna to an amplifier when the antenna is coupled to the input port and the amplifier is connected to the output port; and
in the off state of the switch, isolating a transmit signal from the amplifier when the transmit signal is outputted from a radar transmitter to the antenna and leaks to the input port.

11. A RADAR system comprising the device of claim 1 and further comprising:
a duplexer having a first input, a second input, and an output;
a transmitter connected to the first input;
an amplifier connected to the second input;
an antenna connected to the output of the duplexer; and
the input port of the switch connected to the second input of the duplexer and the amplifier connected to the output port of the switch.

12. The device of claim 1, wherein the signal comprises a G band frequency or a frequency in a range of 100-300 GHz and the waveguides, the coupler, and the frequency multipliers are configured or operable for the frequency.

13. The device of claim 1, wherein the signal transmitted from the input port to the output port in an on state of the switch has a frequency between 100 GHz and 500 THz and the waveguides, the coupler, and the frequency multipliers are configured or operable for the frequency

14. The device of claim 1 configured for at least +20 dBm input power of the signal with less than 1.5 dB insertion loss in the on state, <−30 dB isolation between the input port and the output port in the off state, and a switching speed of at least 1 MHz between the off state and the on state.

15. The device of claim 1, wherein the coupler is a quadrature hybrid coupler.

16. The device of claim 1, wherein the at least one first frequency multiplier is formed in a first semiconductor chip suspended in the first waveguide at the first termination and the at least one second frequency multiplier is formed in a second semiconductor chip suspended in the second waveguide at the second termination.

17. The device of claim 1, wherein the waveguides are formed in a metal block.

18. A device useful as a switch, comprising:
an input waveguide coupled to an output waveguide,
a first diode circuit integrated with the input waveguide at a first termination;
a second diode circuit integrated with the output waveguide at a second termination;
wherein the biasing the diode circuits switches the switch between an off state and an on state and achieves high isolation in the off state by absorbing input power in, reflecting the input power from, and frequency multiplying the input power using, diodes in the diodes circuits.

19. One or more chips, comprising:
one or more pairs of frequency multipliers, each of the frequency multipliers comprising an integrated circuit comprising Schottky diodes having inputs for coupling to a waveguide connected to a coupler in a switch, and each of the frequency multipliers configured and balanced to frequency multiply a signal so as to suppress transmission of the signal between an input port and an output port of the switch in an off state.
